(19) United States
(12) Patent Application Publication
(10) Pub. No.: US 2006/0269325 A1
(43) Pub. Date: Nov. 30, 2006

(54) Charging device for xerographic printing apparatus having enhanced voltage uniformity and enhanced handling robustness

(75) Inventor: Eliud Robles-Flores, Webster, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/139,596

(22) Filed: May 31, 2005

(51) Int. Cl. G03G 15/02

(52) U.S. Cl. 399/171

(57) ABSTRACT

A xerographic printing device, including a charging device having a thick grid that includes a first pattern divided by a second pattern. In some embodiments the first pattern is a hex, the second pattern is a solid band, the first pattern is divided into two sections of equal size, each section corresponds to a two-dimensional array of pins, the first pattern is formed by etching, the second pattern is formed by the absence of etching, and the grid is constructed of stainless steel. The charging device can be a corotron, a dicorotron, a scorotron, a discorotoron, a pin corotron, a pin scorotron, or any other charging device of that type.

### BACKGROUND

This application relates generally to xerographic printing devices including charging devices such as DC pin scorotrons, AC dicorotrons, AC discorotrons, and the like.

Xerographic printing machines often include charging devices such a corotron, dicorotron, scorotron or discorotron. A corotron is a wire device. A dicorotron is a corotron where the wire has a glass coating. A scorotron is a corotron with a grid on top of it. Similarly, a discorotron is a dicorotron with a grid on top of it. Other charging devices used in xerographic printing machines include pin corotrons and pin scorotrons. The pin variations of these devices substitute a series of pins for a smooth wire or substitute an etched wire having tips resembling a series of pins in a saw tooth shape. Some of these pin based charging devices include an array of pins comprising two or more lines of pins.

Some xerographic printing machines include a photoreceptor. Some photoreceptors are shaped with a surface resembling a belt. When charging the photoreceptor in a xerographic printing machine, it is desirable for the charge to be uniform around the surface of the belt. Variations in the magnitude of the charge around the surface of the photoreceptor are referred to as charge non-uniformities. Charge non-uniformities result in variations in image intensity in a resulting print where the original image does not vary in intensity. Non-uniformities that occur across the width of the photoreceptor are referred to as crossweb non-uniformities. Non-uniformities that occur along the length of the photoreceptor are referred to as down-web non-uniformities.

When operating a scorotron charging device, a bias voltage is typically applied to the grid. This bias voltage typically corresponds to a charge to which it is desired to charge the photoreceptor. Grid voltages typically range from 300 volts to 1,000 volts. A typical average grid voltage is in the range of 400 to 500 volts.

Some xerographic engines have problems arising from DC pin scorotron “pin arcs”. One cause stems from pin and/or grid contamination. Contamination can be the result of fuser silicone oil volitles getting into the xerographic cavity and subsequently forming silica dendrites on the pins and/or grids of charging device. Further, pin and/or grid contamination can be caused by paper dust, toner and/or toner additives. Pin scorotrons are typically operated under closed loop feedback control with a constant current maintained between the pins and grid. The voltage required to maintain this constant current is called the “operating voltage”. Pin and/or grid contamination often cause variations in this operating voltage. Furthermore the contamination can vary in its electrical conductivity as a function device operation history such as, e.g., powered versus unpowered. This contamination conductivity variation can also cause an operating voltage variation.

When a pin to grid arc occurs, some print engines do an immediate hard-down, requiring clearing of the paper path, a time consuming job. The arc energy is high enough to disrupt communications, which can require a re-boot to restore the machine to operation.

Other causes of pin arcs and voltage non-uniformities include the handling of a grid while removing or installing the device for service during cleaning. Sometimes the handling of the grid during cleaning causes finger dents such as thumb imprints in the grid. These dents and other distortions in the grid inhibit the ability of an electrical charge to pass through the grid at that point. Oils and other substances transferred to the grid from a user's fingers during cleaning can also cause difficulties in an electrical charge passing through the grid at those locations. Some users also employ a frequency of grid cleaning that is excessive. Such user environments create further opportunity for dents, distortions and soiling of the grid to create causes of charge non-uniformity in the photoreceptor.

One common form of distortion in the grid is referred to as center bowing. Center bowing is a condition where the center is bowed outwards towards the outside of the device relative to the edges of the grid. Center bowing often occurs when an excessive force is applied to the grid while cleaning the outer surface of the grid when it is removed from the device. In various exemplary embodiments, a grid includes wings that extend from the top and the bottom of the grid. In various exemplary embodiments, these wings are exposed when the grid is removed for cleaning. Thus, in various exemplary embodiments, the grid sits on its wings during cleaning. In various exemplary embodiments, pressure is applied to the wings and thus to the device during cleaning causing deformities. In various exemplary embodiments, when a device deformed in this manner is replaced after cleaning, unintended pressures on the device tend to cause center bowing.

Center bowing corresponds to a displacement of the grid towards the surface of the photoreceptor. It is not uncommon for this displacement to be large enough that contact occurs between the center bowed grid and the photoreceptor. This contact often leads to scratching of the surface of the photoreceptor. This scratching of the surface of the photoreceptor necessitates expensive repairs or replacements.

Some xerographic printing machines are constructed of a vertical architecture whereby pin-based charging devices are located underneath a developer housing. This vertical architecture creates a situation whereby the pin-based charging device is exposed to contamination from developer materials. For example, when the health of the toner is poor, chunks of the toner can be spit out from the developer housings and fall on the pin-based charging device. Even routine spillage of toner material from the developer housings can contaminate the pin-based charging device in this vertical architecture of a xerographic printing machine. This heightened state of physical soiling of the grids on the charging devices necessitates a greater frequency of handling and cleaning those grids. Again, this greater frequency of handling and cleaning the grids creates greater opportunity for distortions in the grid and the transfer of oils and other materials from the fingers of the grid handler to the grid surface. As described above, this creates a higher risk of corresponding component damage.

With respect to the architecture of the xerographic printing machine, one convention refers to points furthest inside the machine, that is, points furthest away from a user standing in front of the machine, as inboard portions of the machine. Similarly, according to this convention, portions of the machine closest to the front of the machine, that is, points nearest where a user stands, are referred to as outboard portions of the machine. In one architecture for a xerographic printing machine, the Crossweb orientation of the photoreceptor corresponds to the inboard to outboard or outboard to inboard direction. Similarly, according to this nomenclature, the down-web direction is also referred to as the process direction.

### SUMMARY

In various exemplary embodiments, the grid on a dual pin scorotron includes a hex pattern. In various exemplary embodiments, the hex pattern is etched onto the grid screen from stainless steel. In various exemplary embodiments, a band is formed bisecting the hex pattern of the grid. In various exemplary embodiment, the band is formed by omitting the etching process from a portion of the grid where the band is to be formed. In various exemplary embodiments, the band is a narrow solid band running the length of the center of the grid. Thus, in various exemplary embodiments, the band separates the hex portion or open area of the grid into two equal halves. In various exemplary embodiments, the halves of the grid separated by the band correspond to two arrays of pins. In various exemplary embodiments, the structure assists in focusing the flow of ions from the pins to the photoreceptor thus improving the ion flow. Similarly, in various exemplary embodiments, the solid band in the center of the grid enhances the field at the pin tips.

In various exemplary embodiments, all four colors of the print process are transferred in a single step when forming the image. According to one nomenclature, this process is referred to as the image-on-image or IOI process. In other exemplary embodiments, two or more colors are transferred sequentially, not simultaneously.

In various exemplary embodiments, more than one charging device is used. Thus, in various exemplary embodiments a spin scorotron is used as a primary charging device and a discorotron is used as a secondary recharging device. In various exemplary embodiments, the spin scorotron charges the photoreceptor to a voltage higher than the desired voltage and then a discorotron is used to gradually dissipate some of the overcharged voltage resulting in a more uniform charge.

In various exemplary embodiments, center bowing of a grid is prevented. In various exemplary embodiments, the prevention of center bowing results in the prevention of scratching of a photoreceptor. In various exemplary embodiments, the device thus reduces the frequency of replacing a photoreceptor. Therefore, in various exemplary embodiments the device saves money.

In various exemplary embodiments, a current or wind created in the ionized air at the tips of the pins of the charging device is more concentrated. As described in more detail hereinafter, the various exemplary embodiments achieve an enhanced voltage uniformity and an enhanced handling robustness in photoreceptor charging devices used in xerographic printing machines.

Thus, an exemplary printing machine comprises a charging device that forms a variable charging device operating voltage. In one exemplary embodiment of a printing machine, a pin scorotron charging device operates on a constant current of 2.085 mA. The power supply output voltage varies to maintain this constant pin current. A pin voltage monitor signal is available to the machine control system along with the grid voltage. The pin to grid voltage can be calculated. It is believed that a pattern exists of decreasing pin to grid voltage and more voltage swinging before an arc occurs. New or well-cleaned charging devices do not exhibit this decrease in pin to grid voltages.

In various exemplary embodiments, a High Frequency Service Interval cleaning interval remains on the faulted charging device. This information can be used to instruct an operator to clean or replace the charging device. In various exemplary embodiments, this determination depends on the run time since the last cleaning. A charging device that trips an “Anticipated Arc Soon” fault shortly after a previous cleaning would be replaced. A fault that occurs close to the cleaning interval would instruct the operator to clean the device.

These and other problems overcome by, and other features and advantages of this invention, are described in, or are apparent from, the following detailed description of various exemplary embodiments according to this invention.

### BRIEF DESCRIPTION OF THE DRAWINGS

Various exemplary embodiments of this invention will be described in detail, with reference to the following figures, wherein:

FIG. 1 is a perspective schematic of one exemplary embodiment of a pin scorotron with the hex pattern of the grid removed;

FIG. 2 is a perspective schematic of one exemplary embodiment of an AC dicorotron with the hex pattern of the grid removed;

FIG. 3 is a perspective schematic of one exemplary embodiment of a charge-recharge station including one pin scorotron and three AC dicorotrons with the hex pattern of their grids removed;

FIG. 4 is a top plan view of an exemplary embodiment of an undistorted grid;

FIG. 5 is a top plan view of an exemplary embodiment of a grid having finger dents and handling distortions;

FIG. 6 is an exemplary embodiment of a grid having a center band;

FIG. 7 is a graph showing exemplary test results of various exemplary embodiments of grids;

FIG. 8 is a graph showing other test results of other exemplary embodiments of grids;

FIG. 9 is a graph showing other exemplary data from the exemplary test results on the exemplary embodiments of grids of FIG. 8;

FIG. 10 is a graph showing other exemplary test results of other exemplary embodiments of grids;

FIG. 11 is a graph showing other exemplary test results of other exemplary embodiments of grids;

FIG. 12 is a graph showing other exemplary test results of the exemplary embodiments of grids of FIG. 11; and

FIG. 13 is a graph showing other exemplary test results of other exemplary embodiments of grids.

### DETAILED DESCRIPTION OF EMBODIMENTS

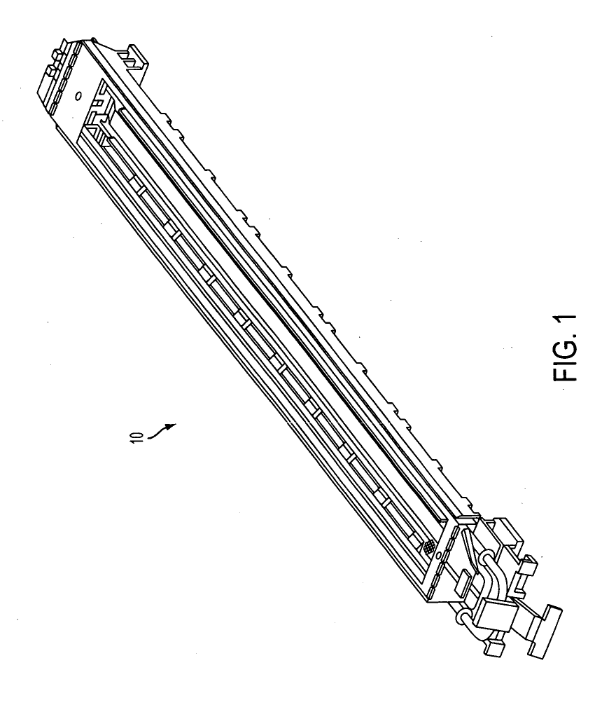

FIG. 1 is a perspective schematic of one exemplary embodiment of a pin scorotron 10 with the hex pattern of the grid removed. Pin scorotrons are well known in the field of xerographic charging devices. In various exemplary embodiments, any currently known or later developed style of pin scorotron may be used.

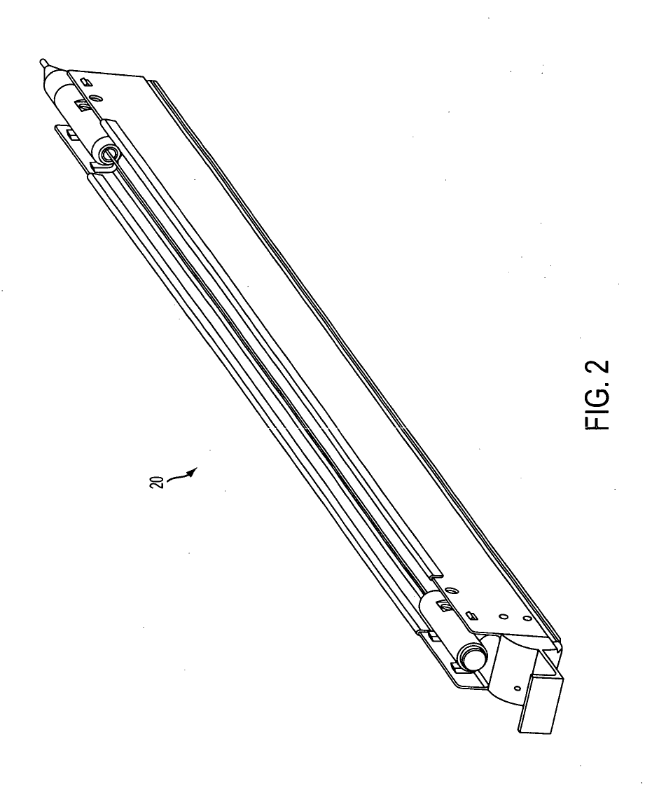

FIG. 2 is a perspective schematic of one exemplary embodiment of an AC dicorotron 20 with the hex pattern of the grid removed. AC dicorotrons are well known in the field of xerographic charging devices. In various exemplary embodiments, any type of AC dicorotron 20 currently known or later developed may be used.

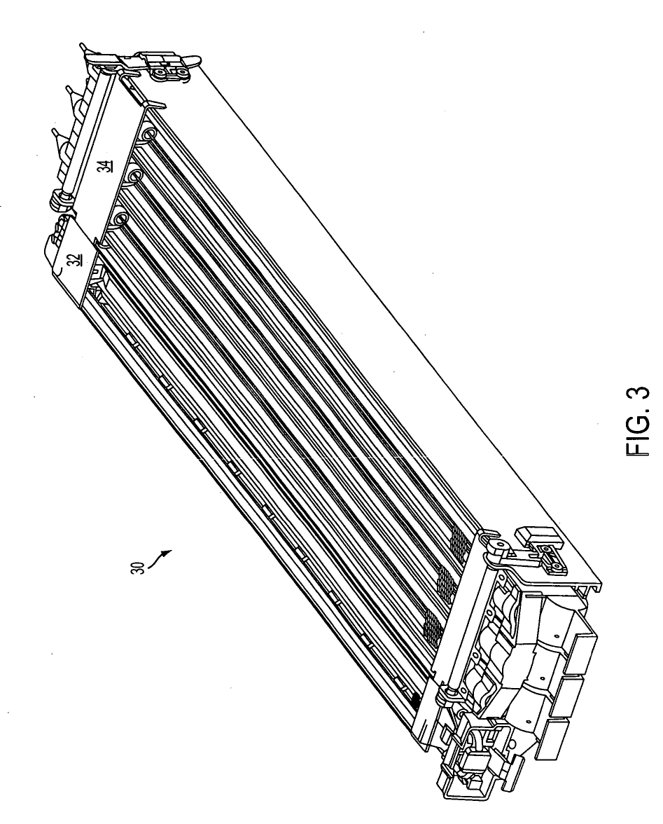

FIG. 3 is a perspective schematic of one exemplary embodiment of a charge-recharge station 30. The exemplary charge-recharge station 30 includes one pin scorotron in housing 32 and three AC dicorotrons in housing 34. The hex pattern of the grids are removed from the top of the pin scorotron in housing 32 and from the top of the three AC dicorotrons in housing 34. In various exemplary embodiments, any currently known or later developed style of charge-recharge station 30 may be used. Thus, in various exemplary embodiments, a charge-recharge station 30 is employed including a number of pin scorotrons other than one. Similarly, in various exemplary embodiments, a charge-recharge station 30 is employed using a number of AC dicorotrons other than three. Likewise, in various exemplary embodiments, a charge-recharge station 30 is employed using one or more type of xerographic charging device other than a pin scorotron or an AC dicorotron. In various exemplary embodiments, a charge-recharge station 30 is employed using any combination of known or later developed type of xerographic charging device.

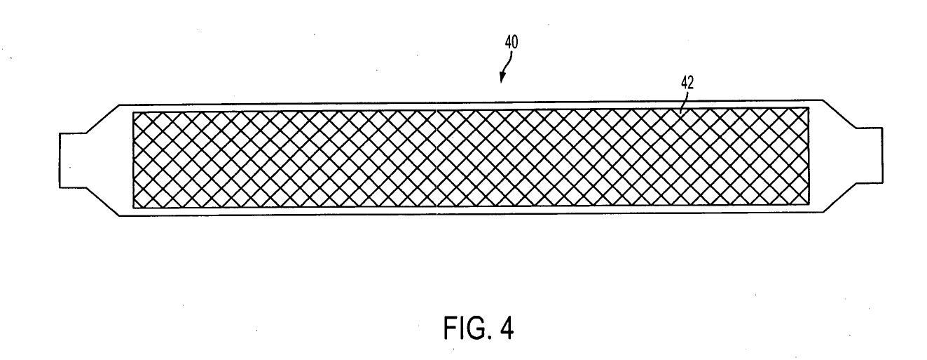

FIG. 4 is a top plan view of an exemplary embodiment of an undistorted grid 40. The exemplary undistorted grid 40 includes a hex pattern 42 (shown as diamonds or squares for simplicity). The exemplary hex pattern 42 is a large rectangle covering almost all of the surface area of the exemplary grid 40. The exemplary hex pattern 42 of exemplary grid 40 is entirely undistorted. In various exemplary embodiments, the grid 40 is constructed of solid stainless steel. In various exemplary embodiments, the grid 40 is only 0.1 mm thick.

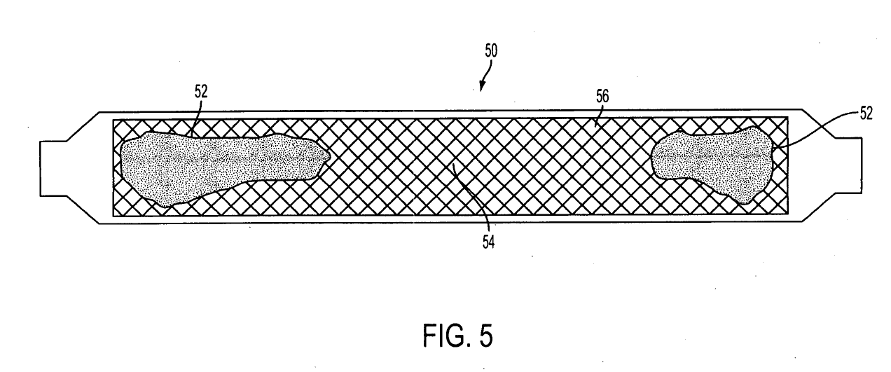

FIG. 5 is a top plan view of an exemplary embodiment of a grid 50 having finger dents 52 and other exemplary handling distortions 54. Exemplary grid 50 corresponds to exemplary grid 40 except as follows. Exemplary grid 50 includes a hex pattern 56 that is distorted when compared to exemplary hex pattern 42. The distortions in hex pattern 56 can result from handling of the exemplary grid 50. One common distortion is center bowing 54. Center bowing is a deformity in the grid 50 caused by handling the grid. The center bowing 54 is a common handling distortion with the accompanying problems described above. The finger dents 52 are another common handling distortion to the hex pattern 56 of the grid 50. The problems associated with finger dents 52 in the grid 50 are also described above.

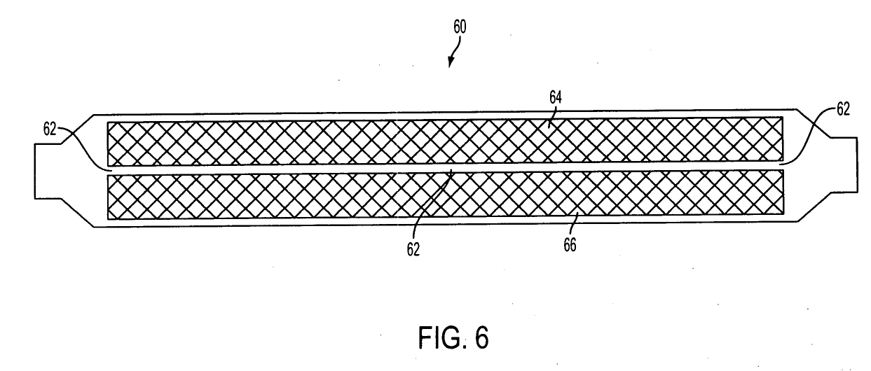

FIG. 6 is an exemplary embodiment of a grid 60 having a center band 62. The center band 62 divides the grid 60 into an exemplary first section 64 and an exemplary second section 66. Exemplary first section 64 and exemplary second section 66 are both rectangles having an equal size. Thus, the center band 62 passes through the center of the grid 60. In various other exemplary embodiments, the rectangles do not have an equal size.

First section 64 and second section 66 both include a hex pattern. The hex pattern of first section 64 and second section 66 is similar to hex pattern 42 on the exemplary grid 40 in FIG. 4.

In various exemplary embodiments, the hex pattern in first section 64 and second section 66 is formed by etching. In various exemplary embodiments, any known etching process is used to form the hex pattern. In various exemplary embodiments, the pattern in first section 64 and second section 66 is a pattern other than a hex pattern.

In various exemplary embodiments, the center band 62 is part of the original material from which the grid 60 is constructed and is formed by using a mask to prevent the etching process that forms first section 64 and second section 66 from etching the section where the center band 62 is formed. In the exemplary embodiment shown in FIG. 6, the center band 62 is a thin, solid strip. In various exemplary embodiments, the center band 62 is a section that is wider than the exemplary center band 62 shown in FIG. 6. In various exemplary embodiments, the center band 62 is not solid, but includes a pattern. In various exemplary embodiments, the pattern of the first section 64 and the second section 66 is different than the pattern of the center band 62.

In a preferred embodiment, the exemplary grid 60 is placed over a dual-pin scorotron. Thus, in this exemplary embodiment, an array of pins in the dual-pin scorotron is under each of the first section 64 and the second section 66. In various exemplary embodiments, an array of pins runs down the center of the longitudinal length of first section 64 and second section 66.

In various exemplary embodiments, the width of the center band 62 is 2 mm. In various exemplary embodiments, the grid 60 is constructed with a higher than normal thickness. Thus, in various exemplary embodiments, the grid is 0.2 mm thick or more.

According to one nomenclature, an exemplary grid 60 that is 0.1 mm thick with a center band 62 that is 2 mm wide is referred to as a banded grid. According to another nomenclature, an exemplary grid 60 that is 0.2 mm thick is referred to as a thick grid or a tough grid. According to another nomenclature, an exemplary grid 60 that is 0.2 mm thick with a center band 62 that is 2 mm wide is referred to as a thick-banded grid or a tough-banded grid. The exemplary embodiments of grid 60 where the grid is a thick grid or a tough grid also reduce the negative effects upon the grid caused by handling the grid as described above.

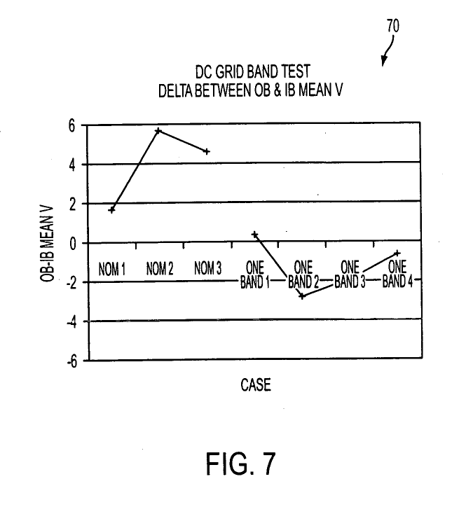

FIG. 7 is a graph 70 showing exemplary test results of various exemplary embodiments of grids. The data charted in graph 70 corresponds to the outboard (OB) to inboard (IB) mean voltage (V) measured in experimental tests of two different exemplary embodiments of a grid.

In the experiments charted in graph 70, multiple crossweb measurements of the outboard to inboard mean voltage were taken. The difference (Delta) between the outboard mean voltage and the inboard mean voltage of those multiple measurements is plotted in the graph 70. These mean voltage readings correspond to the efficiency of the charging device incorporating the exemplary grid tested. The first exemplary grid tested was a grid corresponding to the exemplary grid 40 shown in FIG. 4. This grid is referred to as a nominal grid (Nom). The nominal grid was tested three times. The results of this test data are plotted as data points corresponding to Nom 1, Nom 2 and Nom 3 on the X-axis of the graph 70. The difference (Delta) between the outboard mean voltage and the inboard mean voltage for these three tests were nearly two volts, nearly six volts and nearly five volts for test 1 (Nom 1), test 2 (Nom 2), and test 3 (Nom 3).

The second exemplary embodiment of a grid tested corresponds to the exemplary grid 60 shown in FIG. 6, having one center band 62. This exemplary embodiment of a grid 60 was tested four times. The difference between the outboard mean voltage and the inboard mean voltage in these four tests was slightly over zero, less than negative two, around negative two and nearly zero in the first, second, third and fourth test as plotted in graph 70 (One Band 1, One Band 2, One Band 3, and One Band 4, respectively).

This test data shows that the delta between the outboard and inboard mean voltage for the exemplary grid 60 is substantially lower on average than the delta between outboard and inboard mean voltage for the exemplary grid 40. In other words, the addition of center band 62 greatly reduces the delta between inboard and outboard mean voltage in a grid. This corresponds to significant improvement in the efficiency and non-uniformity reduction with which the charging device on which exemplary grid 60 is installed operates.

The exemplary tests described above were performed randomly to minimize the effect of some system error or other system interaction on the results of the tests. The exemplary tests were based on a five percent risk. Thus, the difference between the test results plotted in graph 70 for exemplary grid 40 and exemplary grid 60 with center band 62 may be fairly attributed to the presence of the center band 62 in exemplary grid 60.

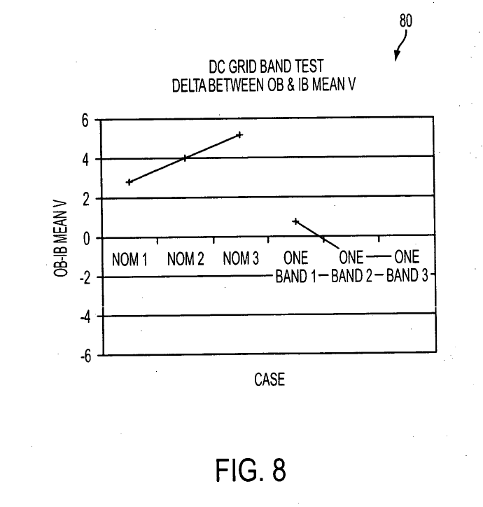

FIG. 8 is a graph 80 showing other test results of other exemplary embodiments of grids. The grids tested in exemplary tests that are charted in graph 80 correspond to the grids tested in connection with graph 70. In graph 80, the results of the tests are plotted based on the difference between outboard and inboard mean voltage limited to a range of six times the standard deviation of the data. In other words, test results plotted in graph 80 correspond to the test results plotted in graph 70 except that spikes in the data in excess of six times the standard deviation are filtered out before compiling the mean voltage data that is plotted in graph 80. Because six times the standard deviation corresponds to 99.9% of the full range of data, it is believed that the spikes filtered out when compiling the data plotted in graph 80 are unrealistic data points.

Moving from left to right along the X-axis in graph 80, the data plotted therein shows a difference between the outboard and inboard mean voltage for exemplary grid 60 of nearly three volts (Nom 1), almost exactly four volts (Nom 2), and slightly more than five volts (Nom 3). Still moving from left to right, the data plotted in graph 80 shows a delta between inboard and outboard mean voltage for exemplary grid 60 of less than one volt (One Band 1) about negative one volt (One Band 2) and about negative one volt (One Band 3). Thus, the data plotted in exemplary graph 80 again confirms that the delta between inboard and outboard mean voltage for exemplary grid 40 is much greater than the delta between outboard and inboard mean voltage for exemplary grid 60. This means that the data plotted in exemplary graph 80 again confirms that the addition of the center band 62 results in a significant increase in the efficiency with which the charging device incorporating exemplary grid 60 operates. Quantifying this conclusion, the voltage uniformity improvement achieved by the exemplary grid 60 over the exemplary grid 40 is approximately 12 percent. The test results plotted in graph 80 were performed under testing conditions the same as the testing conditions described above in connection with graph 70.

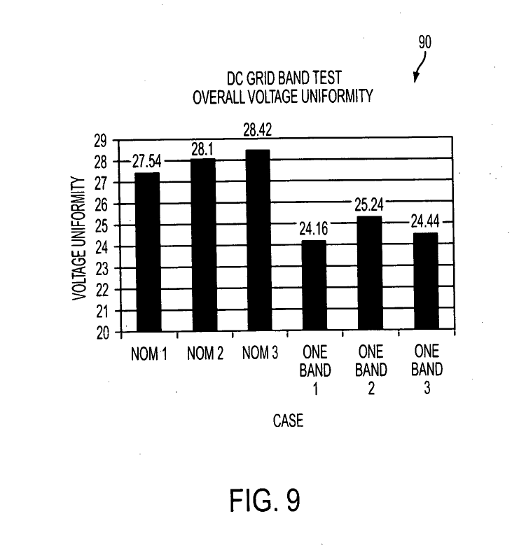

FIG. 9 is a graph 90 showing other exemplary data from the exemplary test results on the exemplary embodiments of grids of FIG. 8. Exemplary data plotted in graph 90 corresponds to the overall voltage uniformity of the exemplary grids tested in connection with graph 80. Thus, the X-axis in FIG. 9 is identical to the X-axis in FIG. 8. The Y-axis in FIG. 9 represents overall voltage uniformity rather than a difference in outboard to inboard mean volts.

Reading from left to right along the X-axis of FIG. 9, the tests on the exemplary grid corresponding to grid 40 had an overall voltage uniformity of 27.54 volts (Nom 1), 28.1 volts (Nom 2) and 28.42 volts (Nom 3), while the tests performed on the exemplary grid corresponding to grid 60 had an overall voltage uniformity of 24.16 volts (One Band 1), 25.24 volts (One Band 2) and 24.44 volts (One Band 3).

The data plotted in graph 90 further confirms the functional superiority of a grid in a charging device when the grid includes a center band 62 compared with a grid that does not include a center band 62. This improvement is obvious given the improved voltage uniformity plotted in graph 90. These improvements will be amplified in greater detail below.

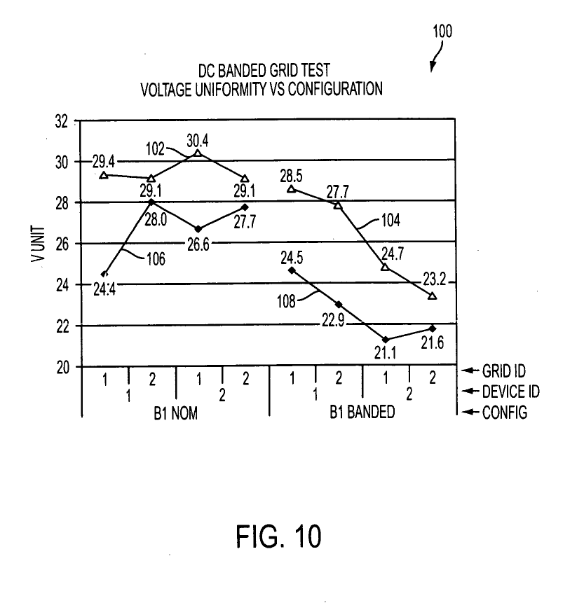

FIG. 10 is a graph 100 showing other exemplary test results of other exemplary embodiments of grids. In exemplary test results depicted in graph 100, again, two exemplary grids were tested. Curve 102 and curve 106 plotted on the left portion of the X-axis in graph 100 correspond to test results for a grid consistent with exemplary grid 40. Curve 104 and curve 108 plotted on the right half of the X-axis in graph 100 corresponds to an exemplary grid consistent with exemplary grid 60. For these tests, two versions of each exemplary grid were tested. Further, each of the paired exemplary grids were tested on two different exemplary charging devices. Thus, moving from left to right across the X-axis in graph 100 there are eight data points in each plot.

The difference between the two configurations of the exemplary grids tested in graph 100 is identified along the X-axis by the “Config” arrow. The B1 Nom configuration corresponds to exemplary grid 40. The B1 Banded configuration corresponds to the exemplary grid 60. For the “Device ID” label along the X-axis, numbers 1 and 2 correspond to the first and second charging devices on which each grid was tested. The two versions of each exemplary grid tested on each device are also labeled 1 and 2, and are identified as the “Grid ID” numbers along the X-axis.

The upper plots 102 and 104 correspond to data obtained at testing conditions of an average grid voltage of 1,000 volts (V_{g}). The lower plots 106 and 108 in graph 100 correspond to data measured at an average grid voltage of 350 volts (V_{g}).

The Y-axis in graph 100 corresponds to voltage uniformity in units of volts. Thus, the Y-axis in graph 100 has the same values as the Y-axis in graph 90, except that the upper threshold plotted is higher in graph 100 so that all the data points may be represented. As with the test results plotted in FIGS. 7-9, the test results plotted in FIG. 10 again show the superior performance of an exemplary grid 60 having a center band 62 in comparison with an exemplary grid 40 lacking the center band 62. Upper curve 104 clearly has a better voltage uniformity than upper curve 102, and lower curve 108 clearly has a better voltage uniformity than lower curve 106. For the reasons stated above in connection with the tests depicted in FIGS. 7-9, the test results plotted in curves 102, 104, 106 and 108 correspond to a greater efficiency and thus improved operation of the exemplary grid 60 having center band 62 over the exemplary grid 40 lacking the center band 62.

The testing that yielded the results plotted in graph 100 was performed under testing conditions the same as the testing conditions described above in connection with graph 70, graph 80 and graph 90. For example, each of the 16 data points plotted in graph 100 represents the average of three trials at each of the 16 test conditions. Further, the data plotted in graph 100 demonstrates that at both higher and lower levels of grid voltage V_{g}, the performance of the exemplary grid 60 having the exemplary center band 62 is improved over the exemplary grid 40 lacking the exemplary center band 62.

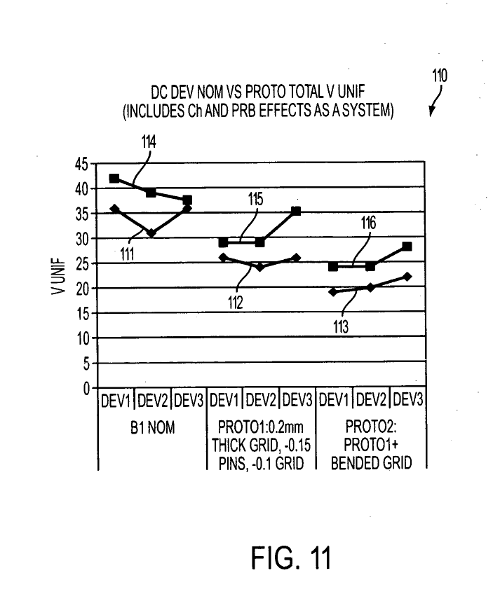

FIG. 11 is a graph 110 showing other exemplary test results of other exemplary embodiments of grids. In the exemplary tests, the results of which are plotted in graph 110, three different exemplary grids were tested. The first exemplary grid corresponds to exemplary grid 40 as previously described. The test results for this exemplary grid are plotted at the left of the X-axis in graph 110.

The test results for the second exemplary grid are plotted in the center of the X-axis in graph 110. The second exemplary grid corresponds to the thick grid or tough grid according to the nomenclature described above.

The test results for the third exemplary grid plotted in graph 110 is at the right of the X-axis in graph 110. This third exemplary grid corresponds to the thick- or tough-banded grid described above.

As with the exemplary grids tested as described above in connection with FIG. 10, each of the three exemplary grids tested in connection with FIG. 11 were tested on three exemplary charging devices. The three exemplary charging devices are labeled on the X-axis of graph 110 as device 1 (Dev 1), device 2 (Dev 2), and device 3 (Dev 3). For each of the three exemplary grids tested on each of the three exemplary devices, data was obtained at two different values of grid voltage (V_{g}). Lower curve 111, lower curve 112, and lower curve 113 are plots of test data obtained with a total voltage uniformity V_{g} of about 300 volts. Upper plot 114, upper plot 115, and upper plot 116 are plots of test data obtained at a total voltage uniformity V_{g} of about 800 volts. The effects plotted in graph 110 include the effects of charging and the photoreceptor belt as a complete system.

The data plotted in graph 110 demonstrate that the performance of an exemplary embodiment of a grid that is 0.2 mm thick is better than the performance of an exemplary embodiment of a grid that is 0.1 mm thick, even at two divergent grid voltages V_{g}. This is evident because upper curve 115 has a better voltage uniformity than upper curve 114 and lower curve 112 has a better voltage uniformity than lower curve 111.

Similarly, the test results plotted in graph 110 demonstrate that the combination of a grid thickness of 0.2 mm and a center band 62 enables performance superior even to the performance of a grid having a 0.2 mm thickness but no center band 62 at two divergent values of grid voltage V_{g}. This is evident because upper curve 116 has a better voltage uniformity than upper curve 115 and lower curve 113 has a better voltage uniformity than lower curve 112.

Other than the differences described above, the test conditions for the exemplary tests plotted in graph 110 were the same as the test conditions described above in connection with the tests plotted in graph 70, graph 80, graph 90, and graph 100.

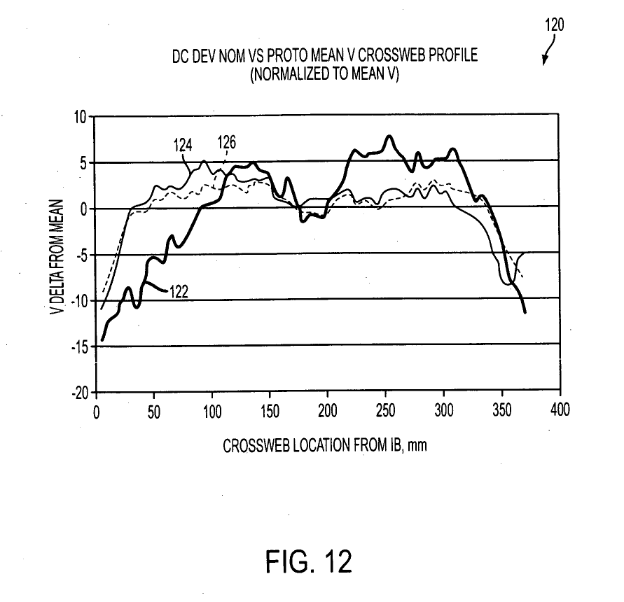

FIG. 12 is a graph 120 showing other exemplary test results of the exemplary embodiments of grids of FIG. 11. Graph 120 depicts three plots of inboard to outboard or crossweb profiles of the difference in grid voltage V_{g} from the mean crossweb profile voltage. The X-axis in graph 120 corresponds to the crossweb location from an inboard location of 0 mm to an outboard location of 400 mm. The mean crossweb profile voltage is zero on the Y-axis in graph 120.

Curve 122 corresponds to the B1 Nom grid described above in connection with FIG. 11. Curve 124 corresponds to the Proto1 grid described above in connection with FIG. 11. Curve 126 corresponds to the Proto2 grid described above in connection with FIG. 11. The B1 Nom grid is similar to exemplary grid 40. The Proto1 grid is similar to the thick or tough grid described above. The Proto2 grid is similar to the thick- or tough-banded grid described above.

In the plots depicted in graph 120, flatter curves correspond to better performance. This is true because flatter curves have a smaller deviation from the mean crossweb voltage. An ideal curve would be perfectly flat at the mean of 0 volts on the Y-axis. Curve 126 is the flattest of the three curves plotted in graph 120 and curve 122 is the least flat of the three curves plotted in graph 120.

Curve 122, curve 124 and curve 126 all have tails. The tails represent edge effects evident at crossweb locations from 0 mm to about 50 mm and from about 325 mm to about 375 mm. The skew of the data plotted in curve 122, curve 124 and curve 126 refers to the distance of a given data point from the mean of 0 volts. Curve 122, curve 124 and curve 126 all have skewed tails as a result of edge effects on each respective exemplary grid. Although the skewed tails are not totally eliminated in any of the exemplary grids tested, the thick or tough grid and the thick-banded grid have dramatically reduced skew. This skew improvement is particular evident between the crossweb locations of 0 to about 50 mm.

Referring again to FIG. 9, the data plotted in curve 90 also shows a skew improvement associated with the inclusion of a center band 62 on exemplary grid 60. The greater the skew of the tails, the greater (and thus worse) the measured value of voltage uniformity represented in curve 90. It is estimated that the skew improvement obtained from a grid having a center band 62, when compared with an exemplary grid such as grid 40 is around 88 percent. This skew improvement is also evident in FIG. 7 and FIG. 8.

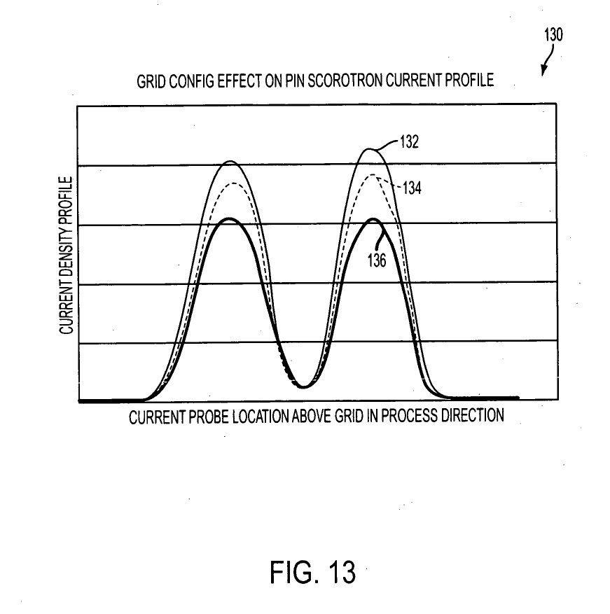

FIG. 13 is a graph 130 showing other exemplary test results of other exemplary embodiments of grids. Graph 130 includes upper curve 132, lower curve 136 and central curve 134. Lower curve 136 corresponds to data plotted from tests performed on a grid corresponding to exemplary grid 40. Central curve 134 corresponds to test data obtained from tests performed on an exemplary thick grid described above. Upper curve 132 corresponds to test data obtained from tests performed on an exemplary grid corresponding to the thick-banded grid or tough-banded grid described above.

The Y-axis in exemplary graph 130 corresponds to the location of a current probe above the tested grid with respect to a process direction of the tested grid. The X-axis of the exemplary graph 130 corresponds to the profile of the current density on the tested grid. By superimposing upper curve 132, middle curve 134, and lower curve 136 in this manner, the relative improvements of the tested grids is apparent. The density measured in this manner is equal to the total measured current divided by the number of pins through which a constant current is applied to each pin tip. In other words, the current density represents an average or mean current per pin.

The higher humps of the curves plotted in graph 130 correspond to a strengthened corona beam. A strengthened corona beam corresponds to a more concentrated corona wind. A more concentrated corona wind corresponds to a higher charge at the tips of the pins. Thus, the higher the humps plotted in exemplary graph 130, the more improved the performance of the charging device incorporating each respective exemplary grid.

The improvements described above correspond to an enhancement in the field at the pin tips. This enhancement in the field helps focus the flow of the ions from the pins to the photoreceptor. A more focused flow of the ions from the pins to the photoreceptor represents an improvement in the performance of the charging device incorporating the tested grid.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. The xerographic printing device, comprising a charging device that includes a grid, wherein the grid includes a first pattern divided by a second pattern.

2. The xerographic printing device according to claim 1, wherein the first pattern is a hex pattern.

3. The xerographic printing device according to claim 1, wherein the second pattern is a solid band.

4. The xerographic printing device according to claim 3, wherein the first pattern is divided into two sections of equal size.

5. The xerographic printing device according to claim 4, wherein each section corresponds to a two-dimensional array of pins.

6. The xerographic printing device according to claim 1, wherein the first pattern is formed by etching.

7. The xerographic printing device according to claim 6, wherein the second pattern is formed by the absence of etching.

8. The xerographic printing device according to claim 1, wherein the grid is constructed of stainless steel.

9. The xerographic printing device according to claim 1, wherein the charging device is selected from the list comprising a corotron, a dicorotron, a scorotron, a discorotron, a pin corotron, and a pin scorotron.

10. A grid for a charging device of a xerographic printing device, comprising a first pattern divided by a second pattern.

11. The grid according to claim 10, wherein the first pattern is a hex pattern.

12. The grid according to claim 10 wherein the second pattern is a solid band.

13. The grid according to claim 12, wherein the first pattern is divided into two sections of equal size.

14. The grid according to claim 13, wherein each section corresponds to a two-dimensional array of pins.

15. The grid according to claim 10, wherein the first pattern is formed by etching.

16. The grid according to claim 15, wherein the second pattern is formed by the absence of etching.

17. The grid according to claim 10, wherein the grid is constructed of stainless steel.

18. The grid according to claim 10, wherein the charging device is selected from the list consisting of a corotron, a dicorotron, a scorotron, a discorotron, a pin corotron, and a pin scorotron.

19. A grid for a charging device of a xerographic printing device, comprising a first pattern divided by a second pattern, the second pattern is a solid band dividing the first pattern into two sections and corresponding to a two-dimensional array of pins in the charging device, and the grid is more than 0.1 mm thick.

20. The grid according to claim 19, wherein the grid is at least 0.2 mm thick the first pattern is a hex pattern, and the charging device is selected from the list consisting of a pin corotron and a pin scorotron.
